(19) United States
(12) Patent Application Publication
(10) Pub. No.: US 2026/0062078 A1
(43) Pub. Date: Mar. 5, 2026

(54) Scooter Stabilization Device

(71) Applicant: James Hoover, Florence, AZ (US)

(72) Inventor: James Hoover, Florence, AZ (US)

(21) Appl. No.: 18/816,034

(22) Filed: Aug. 27, 2024

(51) Int. Cl. B62H 1/12

(52) U.S. Cl. CPC B62H 1/12

(57) ABSTRACT

A scooter stabilization device includes a scooter that has a deck and a pair of wheels which roll along a support surface. An extension plank has a cut out which accommodates the deck of the scooter and the extension plank extends laterally beyond opposite sides of the deck. A pair of clamps is each slidably mounted to the extension plank to compress against the deck of the scooter for securing the extension plank to the deck. A pair of rollers is each rotatably disposed on the extension plank to roll along the support surface when the extension plank is attached to the deck of the scooter. Each of the pair of rollers is spaced laterally away from opposing sides of the deck thereby inhibiting the scooter from tipping laterally. In this way the pair of rollers inhibits the user from tipping over when the user is riding the scooter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stabilization devices and more particularly pertains to a new stabilization device for laterally stabilizing a mobility scooter. The device includes an extension plank which has a cutout that accommodates a deck of the scooter such that the extension plank is perpendicularly oriented with the deck. The device includes a pair of clamps which is each slidably attached to the extension plank for compressing against the deck to secure the extension plank to the deck. The device includes a pair of rollers which are each rotatably disposed on a respective clamp. The pair of roller rolls along the support surface to lateral stabilize the mobility scooter thereby inhibiting the mobility scooter from tipping laterally. In this way a user of the mobility scooter is protected from tipping over while the user is employing the mobility scooter.

### (2) Description of Related Art including information disclosed under 37 CFR 1.97 and 1.98

The prior art relates to stabilization devices including an amusement scooter which has a laterally stabilizing unit integrated into the amusement scooter to inhibit the amusement scooter from tipping laterally and a variety of non-motorized scooter devices which each at least includes a scooter with a pair of wheels and a pair of outrigger wheels integrated into the scooter to laterally stabilize the scooter and a vehicle stabilization device that includes a pair of outrigger wheels which are each pivotally attached to a deck of a vehicle to laterally stabilize the vehicle. In no instance does the prior art disclose a scooter stabilization device that includes an extension plank which has a cutout to accommodate a deck of a scooter having the extension plank being perpendicularly oriented with the deck and a pair of clamps slidably attached to the extension plank for compressing against the deck to secure the extension plank to the deck and a pair of rollers each rotatably attached to a respective clamp to laterally stabilize the scooter.

### BRIEF SUMMARY OF THE INVENTION

An embodiment of the disclosure meets the needs presented above by generally comprising a scooter that has a deck and a pair of wheels which roll along a support surface. An extension plank has a cut out which accommodates the deck of the scooter and the extension plank extends laterally beyond opposite sides of the deck. A pair of clamps is each slidably mounted to the extension plank to compress against the deck of the scooter for securing the extension plank to the deck. A pair of rollers is each rotatably disposed on the extension plank to roll along the support surface when the extension plank is attached to the deck of the scooter. Each of the pair of rollers is spaced laterally away from opposing sides of the deck thereby inhibiting the scooter from tipping laterally. In this way the pair of rollers inhibits the user from tipping over when the user is riding the scooter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side in-use view of a scooter stabilization device according to an embodiment of the disclosure.

FIG. 2 is a top perspective view of an extension plank of an embodiment of the disclosure.

FIG. 3 is a front side phantom view of an extension plank of an embodiment of the disclosure.

FIG. 4 is a cross sectional view taken along line 4-4 of FIG. 3 of an embodiment of the disclosure.

FIG. 5 is a front view of an alternative embodiment of the disclosure.

FIG. 6 is a bottom perspective view of an alternative embodiment of the disclosure.

FIG. 7 is a cross sectional view taken along line 7-7 of FIG. 5 of an alternative embodiment of the disclosure.

FIG. 8 is a cross sectional view taken along line 8-8 of FIG. 3 of an extension plank of an embodiment of the disclosure.

FIG. 9 is a bottom view of an extension plank of an embodiment of the disclosure.

### DETAILED DESCRIPTION OF THE INVENTION

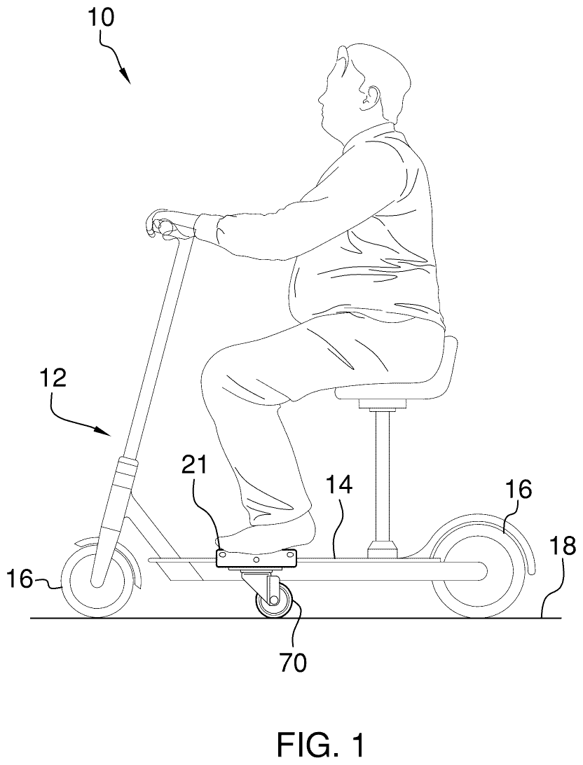

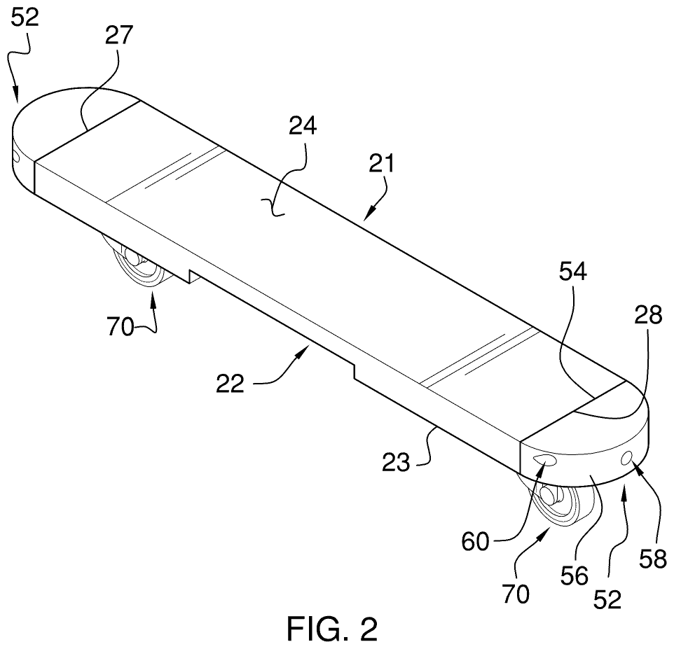

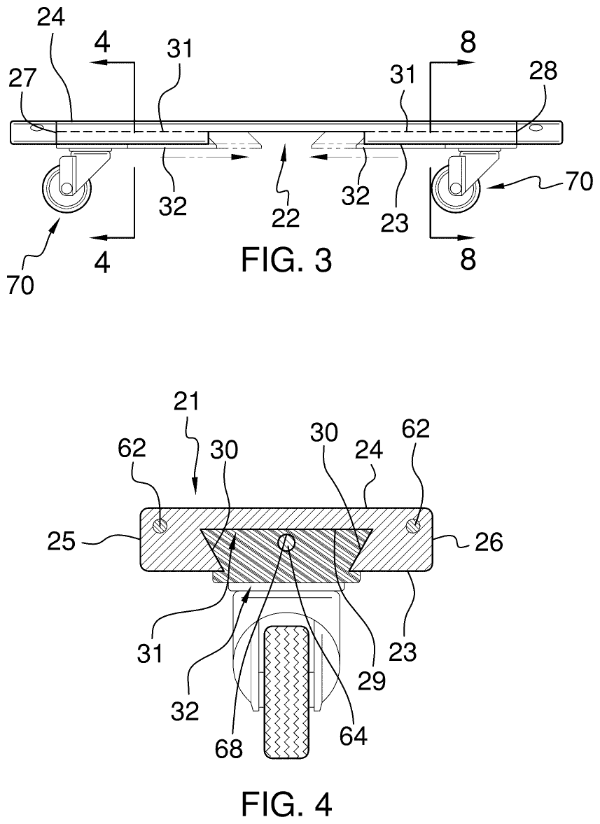

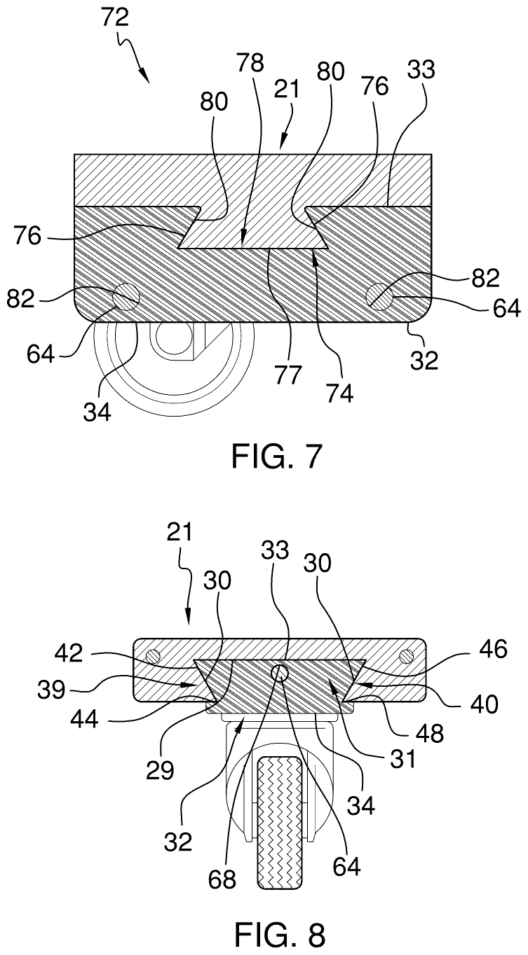

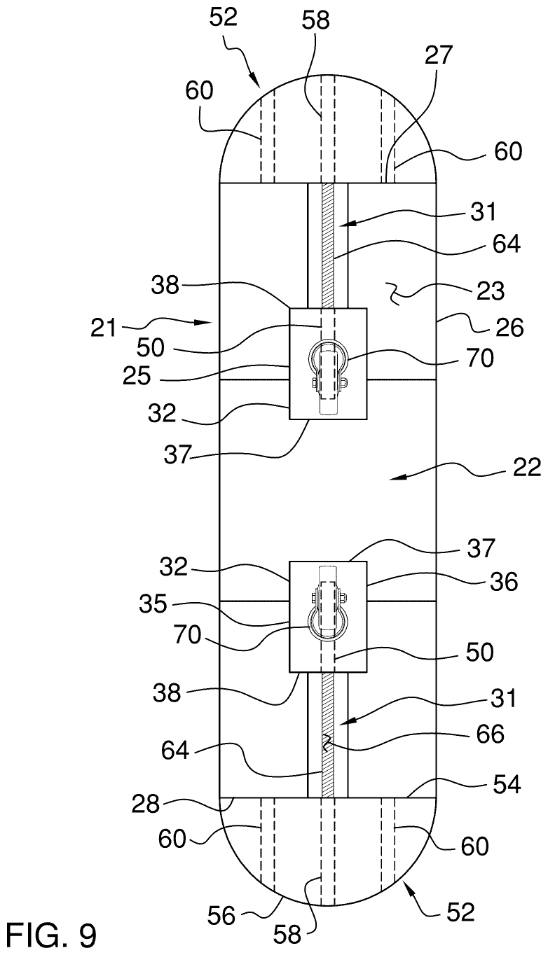

With reference now to the drawings, and in particular to FIGS. 1 through 9 thereof, a new stabilization device embodying the principles and concepts of an embodiment of the disclosure and generally designated by the reference numeral 10 will be described.

As best illustrated in FIGS. 1 through 9, the scooter stabilization device 10 generally comprises a scooter 12 which has a deck 14 and a pair of wheels 16 each rotatably disposed on the scooter 12 thereby enabling the pair of wheels 16 to roll along a support surface 18 having the deck 14 being elevated from the support surface 18. The support surface 18 may be the ground or a floor of a building or any other horizontal support surface upon which the scooter 12 is traveling. The scooter 12 may be an electric mobility scooter of any conventional design that is employed by a user 20 who suffers from limited mobility. An extension plank 21 is provided that has a cut out 22 which accommodates the deck 14 of the scooter 12 when the extension plank 21 is positioned on the deck 14. Additionally, the extension plank 21 is perpendicularly oriented with the deck 14 having the extension plank 21 extending laterally beyond opposite sides of the deck 14.

The cut out 22 extends from a bottom surface 23 of the extension plank 21 toward a top surface 24 of the extension plank 21 and the cut out 22 extends through each of a front surface 25 and a back surface 26 of the extension plank 21. The cut out 22 is centrally located between a first end 27 and a second end 28 of the extension plank 21 and the cut out 22. The extension plank 21 has a pair of channels 31 each extending from the bottom surface 23 of the extension plank 21 toward the top surface 24 of the extension plank 21. Each of the pair of channels 31 extends between a respective one of the first end 27 and the second end 28 of the extension plank 21 and the cut out 22. Each of the pair of channels 31 has an upper bounding surface 29 and a pair of lateral bounding surfaces 30. The upper bounding surface 29 of each of the pair of channels 31 lies on a plane that is oriented parallel to the top surface 24 of the extension plank 21. Each of the pair of lateral bounding surfaces 30 of each of the pair of channels 31 angles toward each other between the upper bounding surface 29 and the bottom surface 23 of the extension plank 21 such that the each of the pair of channels 31 defines a trapezoidal shape.

A pair of clamps 32 is each slidably mounted to the extension plank 21 and each of the pair of clamps 32 is slidable toward or away from each other. Each of the clamps 32 is slidable into the cut out 22 thereby enabling each of the clamps 32 to compress against the deck 14 of the scooter 12 for securing the extension plank 21 to the deck 14. In this way the pair of clamps 32 enables the extension plank 21 to be mounted to a variety of scooters that have decks of varying widths. Each of the pair of clamps 32 has a top side 33 and a bottom side 34 and a first lateral side 35 and a second lateral side 36 and a front side 37 and a back side 38. The front side 37 of each of the pair of clamps 32 slopes rearwardly between the bottom side 34 and the top side 33 such that the deck 14 of the scooter 12 is inhibited from sliding downwardly along the front side 37 of each of the pair of clamps 32 when the pair of clamps 32 is compressed against the deck 14. In this way the extension plank 21 is secured to the deck 14 when the clamps 32 are compressed against the deck 14.

Each of the pair of clamps 32 has a first notch 39 that is recessed into the first lateral side 35 and each of the pair of clamps 32 has a second notch 40 that is recessed into the second lateral side 36. The first notch 39 associated with each of the pair of clamps 32 has a first bounding surface 42 and a second bounding surface 44. The first bounding surface 42 of the first notch 39 associated with each of the pair of clamps 32 angles inwardly between the top surface 24 of a respective clamp 32 and the second bounding surface 44. The second bounding surface 44 of the first notch 39 associated with each of the pair of clamps 32 extends between the first bounding surface 42 and the first lateral side 35 of a respective clamp 32. Furthermore, the second bounding surface 44 of the first notch 39 lies on a plane that is oriented parallel to the bottom side 34 of the respective clamp 32. Additionally, the first bounding surface 42 of the first notch 39 in each of the pair of clamps 32 conforms to a respective one of the lateral bounding surfaces 30 of a respective one of the pair of channels 31 in the bottom surface 23 of the extension plank 21 and the second bounding surface 44 of the first notch 39 in each of the pair of clamps 32 rests against the bottom surface 23 of the extension plank 21.

The second notch 40 associated with each of the pair of clamps 32 has a primary bounding surface 46 and a secondary bounding surface 48. The primary bounding surface 46 of the second notch 40 associated with each of the pair of clamps 32 angles inwardly between the top surface 24 of a respective clamp 32 and the secondary bounding surface 48. The secondary bounding surface 48 of the second notch 40 associated with each of the pair of clamps 32 extends between the primary bounding surface 46 and the first lateral side 35 of a respective clamp 32. Additionally, the secondary bounding surface 48 of the second notch 40 lies on a plane which is oriented parallel to the bottom side 34 of the respective clamp 32. The primary bounding surface 46 of the second notch 40 in each of the pair of clamps 32 conforms to a respective one of the lateral bounding surfaces 30 of a respective one of the pair of channels 31 in the bottom surface 23 of the extension plank 21. The secondary bounding surface 48 of the second notch 40 in each of the pair of clamps 32 rests against the bottom surface 23 of the extension plank 21. Each of the pair of clamps 32 has a screw well 50 extending from the back side 38 toward the front side 37 and each of the pair of clamps 32 is oriented such that the front side 37 of each of the pair of end clamps 32 is directed toward each other.

A pair of end caps 52 is provided and each of the pair of end caps 52 is removably attached to opposing ends of the extension plank 21 with respect to each other. Each of the pair of end caps 52 has a planar end 54 and a rounded end 56 and the planar end 54 of each of the pair of end caps 52 abuts a respective one of the first end 27 and the second end 28 of the extension plank 21. Each of the pair of end caps 52 has a screw hole 58 extending between the rounded end 56 and the planar end 54. Furthermore, the screw hole 58 in each of the pair of end caps 52 is aligned with a respective one of the pair of channels 31 in the extension plank 21. Each of the pair of end caps 52 has a pair of fastener holes 60 which each extends between the rounded end 56 and the planar end 54. Additionally, the screw hole 58 in a respective end cap 52 is positioned between the pair of fastener holes 60 in the respective end cap. A plurality of fasteners 62 extends through a respective one of the pair of fastener holes 60 in a respective one of the pair of ends caps 52 and engages a respective one of the first end 27 and the second end 28 of the extension plank 21 for attaching the end caps 52 to the extension plank 21.

A pair of screws 64 is provided and each of the pair of screws 64 extends through the screw hole 58 in a respective one of the pair of end caps 52 and a respective one of the pair of channels 31 in the extension plank 21. Additionally, each of the pair of screws 64 extends into the screw well 50 in a respective one of the pair of clamps 32. An outer surface 66 of each of the pair of screws 64 threadably engages a bounding surface 68 of the respective screw well 50. Each of the pair of clamps 32 travels toward each other when the pair of screws 64 is rotated in a first direction thereby enabling the pair of clamps 32 to be compressed against the deck 14 of the scooter 12. Conversely, each of the pair of clamps 32 travels away from each other when the pair of screws 64 is rotated in a second direction thereby enabling the pair of clamps 32 to be displaced from the deck 14 of the scooter 12. In this way the extension plank 21 can be removed from the deck 14.

A pair of rollers 70 is provided and each of the pair of rollers 70 is rotatably disposed on the extension plank 21. In this way each of the pair of rollers 70 can roll along the support surface 18 when the extension plank 21 is attached to the deck 14 of the scooter 12. Each of the pair of rollers 70 is spaced apart from each other on the extension plank 21 thereby enabling each of the pair of rollers 70 to be spaced laterally away from opposing sides of the deck 14 with respect to each other. In this way the scooter 12 is inhibited from tipping laterally thereby inhibit the user 20 from tipping over when the user 20 is riding the scooter 12.

Each of the pair of rollers 70 is positioned on the bottom side 34 of a respective one of the pair of clamps 32 and each of the pair of rollers 70 is positioned adjacent to the back side 38 of the respective clamp 32. Additionally, each of the pair of rollers 70 is rotatable on the respective clamp 32 about an axis extending between the top side 33 and the bottom side 34 of the respective clamp 32. In this way the pair of rollers 70 are enabled to travel with the scooter 12 when the scooter 12 is steered to the left or to the right. Furthermore, the pair of rollers 70 inhibits the user 20 from tipping over when the user 20 turns the scooter 12, or when the user 20 is travelling at a slow speed on the scooter 12, thereby enhancing the safety of the user 20 when the user 20 is traveling on the scooter 12. Each of the pair of rollers 70 may comprise a caster or other type of roller that includes a rotatable mount and a wheel that is rotatably attached to the rotatable mount.

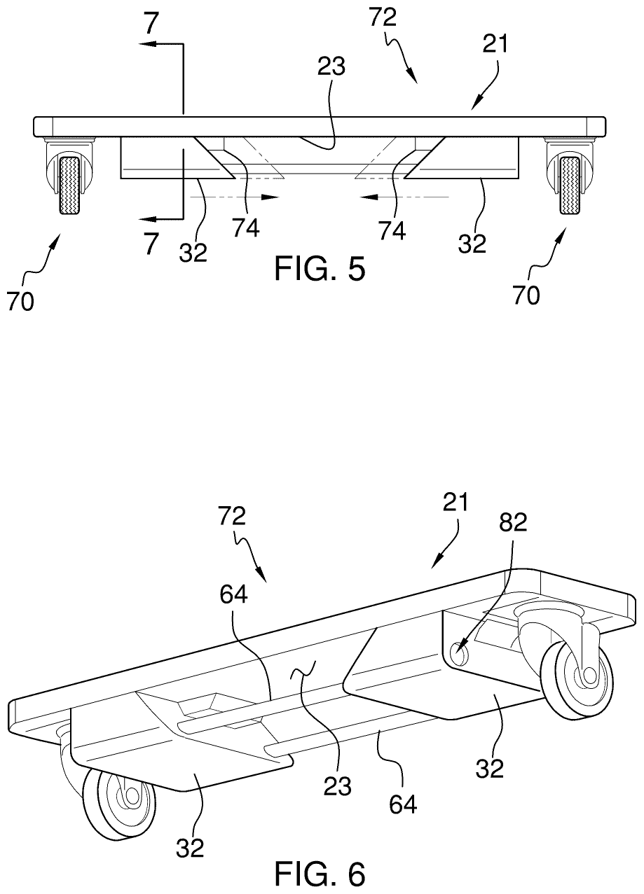

In an alternative embodiment 72 shown in FIGS. 5 through 7, the extension plank 21 has a pair of prominences 74 each extending downwardly from the bottom surface 23 of the extension plank 21. Each of the pair of prominences 74 is spaced from a respective one of the first end 27 and the second end 28 of the extension plank 21 and extends toward a center of the extension plank 21. Each of the pair of prominences 74 has a pair of lateral surfaces 76 which each angles inwardly between a bottom surface 77 of a respective prominence 74 and the bottom surface 23 of the extension plank 21 such that each of the pair of prominences 74 has a trapezoidal shape.

Continuing in the alternative embodiment 72, each of the pair of clamps 32 has a slot 78 extending between the front side 37 and the back side 38 of the clamps 32. The slot 78 in each of the pair of clamps 32 has a pair of lateral bounding surfaces 80 which each angles outwardly between the top side 33 of a respective clamp 32 and the bottom side 34 of the respective clamp 32 such that the slot 78 in each of the pair of clamps 32 has a trapezoidal shape. The slot 78 in each of the pair of clamps 32 insertably receives a respective one of the pair of prominences 74 on the bottom surface 23 of the extension plank 21 having each of the pair of lateral bounding surfaces 30 of the slot 78 in a respective clamp 32 conforming to a respective one of the pair of lateral surfaces 76 of the respective prominence 74.

Continuing in the alternative embodiment 72, each of the pair of clamps 32 has a pair of screw holes 82 each extending between the front side 37 and the back side 38 of a respective clamp 32. Each of the pair of screw holes 82 in the respective clamp 32 is positioned on opposite sides of the slot 78 in the respective clamp 32. Additionally, each of the pair of screws 64 extends through a respective one of the pair of screw holes 82 in each of the pair of clamps 32. Each of the pair of screws 64 threadably engages a bounding surface 84 of the respective screw hole 82 in each of the pair of clamps 32. Each of the pair of clamps 32 travels toward each other on the respective prominence 74 when the pair of screws 64 is rotated in the first direction for compressing the pair of clamps 32 against the deck 14 of the scooter 12. Conversely, each of the pair of clamps 32 travels away from each other on the respective prominence 74 when the pair of screws 64 is rotated in the second direction for displacing the pair of clamps 32 from the deck 14 of the scooter 12. Each of the pair of rollers 70 is rotatably attached to the bottom surface 23 of the extension plank 21. Additionally, each of the pair of rollers 70 is positioned between a respective one of the pair of prominences 74 and a respective one of the first end 27 and the second end 28 of the extension plank 21.

In use, the extension plank 21 is positioned on top of the deck 14 of the scooter 12 and the pair of screws 64 are rotated in the first direction to compress each of the pair of clamps 32 against the deck 14 to secure the extension plank 21 to the deck 14. In this way each of the pair of rollers 70 on the pair of clamps 32 are enabled to roll along the support surface 18 in conjunction with the wheels 16 of the scooter 12. Thus, the pair of rollers 70 stabilized the scooter 12 along a lateral axis thereby inhibiting the scooter 12 from tipping laterally while the scooter 12 is in motion. In this way the user 20 is protected from injury that can result from tipping over on the scooter 12 while the user 20 is turning or while the user 20 is traveling at a reduced speed on the scooter 12. Thus, the user 20 can employ the scooter 12 in a crowded area, for example, at a slow speed without the risk of tipping over and potentially being injured. The screws 64 can be rotated in the second direction to displace the pair of clamps 32 from the deck 14 to facilitate the extension plank 21 to be removed from the scooter 12. In this way the scooter 12 can be positioned in a vehicle, for example, for transporting the scooter 12 in the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scooter stabilization device for stabilizing a two wheeled scooter, said device comprising:
a scooter having a deck and a pair of wheels each being rotatably disposed on said scooter wherein said pair of wheels is configured to roll along a support surface having said deck being elevated from the support surface;
an extension plank having a cut out which accommodates said deck of said scooter when said extension plank is positioned on said deck such that said extension plank is perpendicularly oriented with said deck having said extension plank extending laterally beyond opposite sides of said deck;
a pair of clamps, each of said pair of clamps being slidably mounted to said extension plank, each of said pair of clamps being slidable toward or away from each other, each of said clamps being slidable into said cut out thereby enabling each of said clamps to compress against said deck of said scooter for securing said extension plank to said deck;
a pair of end caps, each of said pair of end caps being removably attached to opposing ends of said extension plank with respect to each other; and
a pair of rollers, each of said pair of rollers being rotatably disposed on said extension plank wherein each of said pair of rollers is configured to roll along the support surface when said extension plank is attached to said deck of said scooter, each of said pair of rollers being spaced apart from each other on said extension plank thereby enabling each of said pair of rollers to be spaced laterally away from opposing sides of said deck with respect to each other thereby inhibiting said scooter from tipping laterally wherein each of said pair of rollers is configured to inhibit the user from tipping over when the user is riding said scooter.

2. The device according to claim 1, wherein:
said cut out extends from a bottom surface of said extension plank toward a top surface of said extension plank;
said cut out extends through each of a front surface and a back surface of said extension plank;
said cut out is centrally located between a first end and a second end of said extension plank;
said extension plank has a pair of channel each extending from said bottom surface of said extension plank toward said top surface of said extension plank;
each of said pair of channels extends between a respective one of said first end and said second end and said cut out;
each said pair of channels has an upper bounding surface and a pair of lateral bounding surfaces;
said upper bounding surface of each of said pair of channels lies on a plane being oriented parallel to said top surface of said extension plank; and
each of said pair of lateral bounding surfaces of each of said pair of channels angles toward each other between said upper bounding surface of a respective channel and said bottom surface of said extension plank such that each of said pair of channels defines a trapezoidal shape;

3. The device according to claim 2, wherein:
each of said pair of clamps has a top side and a bottom side and a first lateral side and a second lateral side and a front side and a back side;
said front side of each of said pair of clamps slopes rearwardly between said bottom side and said top side such that said deck of said scooter is inhibited from sliding downwardly along said front side of each of said pair of clamps when said pair of clamps is compressed against said deck for securing said extension plank to said deck;
each of said pair of clamps has a first notch being recessed into said first lateral side; and
each of said pair of clamps has a second notch being recessed into said second lateral side;
said first notch associated with each of said pair of clamps has a first bounding surface and a second bounding surface;
said first bounding surface of said first notch associated with each of said pair of clamps angles inwardly between said top surface of a respective clamp and said second bounding surface;
said second bounding surface of said first notch associated with each of said pair of clamps extends between said first bounding surface and said first lateral side of a respective clamp having said second bounding surface of said first notch lying on a plane being oriented parallel to said bottom side of said respective clamp;
said first bounding surface of said first notch in each of said pair of clamps conforms to a respective one of said lateral bounding surfaces of a respective one of said pair of channels in said bottom surface of said extension plank; and
said second bounding surface of said first notch in each of said pair of clamps rests against said bottom surface of said extension plank.

4. The device according to claim 3, wherein:
said second notch associated with each of said pair of clamps has a primary bounding surface and a secondary bounding surface;
said primary bounding surface of said second notch associated with each of said pair of clamps angles inwardly between said top surface of a respective clamp and said secondary bounding surface;
said secondary bounding surface of said second notch associated with each of said pair of clamps extends between said primary bounding surface and said first lateral side of a respective clamp having said secondary bounding surface of said second notch lying on a plane being oriented parallel to said bottom side of said respective clamp;
said primary bounding surface of said second notch in each of said pair of clamps conforms to a respective one of said lateral bounding surfaces a respective one of said pair of channels in said bottom surface of said extension plank; and
said secondary bounding surface of said second notch in each of said pair of clamps rests against said bottom surface of said extension plank.

5. The device according to claim 3, wherein:
each of said pair of clamps is oriented such that said front side of each of said pair of end clamps is directed toward each other.

6. The device according to claim 2, wherein:
each of said pair of end caps has a planar end and a rounded end;
said planar end of each of said pair of end caps abuts a respective one of said first end and said second end of said extension plank;
each of said pair of end caps has a screw hole extending between said rounded end and said planar end; and
said screw hole in each of said pair of end caps is aligned with a respective one of said pair of channels in said bottom surface of said extension plank.

7. The device according to claim 6, wherein:
each of said pair of clamps has a front side and a back side;
each of said pair of clamps has a screw well extending from said back side toward said front side;
said device includes a pair of screws;
each of said pair of screws extends through said screw hole in a respective one of said pair of end caps and a respective one of said pair of channels in said extension plank;
each of said pair of screws extends into said screw well in a respective one of said pair of clamps; and
an outer surface of each of said pair of screws threadably engages a bounding surface of said respective screw well.

8. The device according to claim 7, wherein:
each of said pair of clamps travels toward each other when said pair of screws is rotated in a first direction thereby enabling said pair of clamps to be compressed against said deck of said scooter; and
each of said pair of clamps travels away from each other when said pair of screws is rotated in a second direction thereby enabling said pair of clamps to be displaced from said deck of said scooter for removing said extension plank from said deck.

9. The device according to claim 1, wherein:
each of said pair of clamps has a top side and a bottom side and a back side;
each of said pair of rollers is positioned on said bottom side of a respective one of said pair of clamps;
each of said pair of rollers is positioned adjacent to said back side of said respective clamp; and
each of said pair of rollers is rotatable on said respective clamp about an axis extending between said top side and said bottom side of said respective clamp thereby enabling said pair of rollers to travel with said scooter when said scooter is steered to the left or to the right wherein said pair of rollers is configured to inhibit the user from tipping over when the user turns said scooter.

10. A scooter stabilization device for stabilizing a two wheeled scooter, said device comprising:
a scooter having a deck and a pair of wheels each being rotatably disposed on said scooter wherein said pair of wheels is configured to roll along a support surface having said deck being elevated from the support surface;
an extension plank having a cut out which accommodates said deck of said scooter when said extension plank is positioned on said deck such that said extension plank is perpendicularly oriented with said deck having said extension plank extending laterally beyond opposite sides of said deck, said cut out extending from a bottom surface of said extension plank toward a top surface of said extension plank, said cut out extending through each of a front surface and a back surface of said extension plank, said cut out being centrally located between a first end and a second end of said extension plank, said extension plank having a pair of channel each extending from said bottom surface of said extension plank toward said top surface of said extension plank, each of said pair of channels extending between a respective one of said first end and said second end and said cut out, each said pair of channels having an upper bounding surface and a pair of lateral bounding surfaces, said upper bounding surface of each of said pair of channels lying on a plane being oriented parallel to said top surface of said extension plank, each of said pair of lateral bounding surfaces of each of said pair of channels angling toward each other between said upper bounding surface of a respective channel and said bottom surface of said extension plank such that each of said pair of channels defines a trapezoidal shape;
a pair of clamps, each of said pair of clamps being slidably mounted to said extension plank, each of said pair of clamps being slidable toward or away from each other, each of said clamps being slidable into said cut out thereby enabling each of said clamps to compress against said deck of said scooter for securing said extension plank to said deck, each of said pair of clamps having a top side and a bottom side and a first lateral side and a second lateral side and a front side and a back side, said front side of each of said pair of clamps sloping rearwardly between said bottom side and said top side such that said deck of said scooter is inhibited from sliding downwardly along said front side of each of said pair of clamps when said pair of clamps is compressed against said deck for securing said extension plank to said deck, each of said pair of clamps having a first notch being recessed into said first lateral side, each of said pair of clamps having a second notch being recessed into said second lateral side, said first notch associated with each of said pair of clamps having a first bounding surface and a second bounding surface, said first bounding surface of said first notch associated with each of said pair of clamps angling inwardly between said top surface of a respective clamp and said second bounding surface, said second bounding surface of said first notch associated with each of said pair of clamps extending between said first bounding surface and said first lateral side of a respective clamp having said second bounding surface of said first notch lying on a plane being oriented parallel to said bottom side of said respective clamp, said first bounding surface of said first notch in each of said pair of clamps conforming to a respective one of said lateral bounding surfaces of a respective one of said pair of channels in said bottom surface of said extension plank, said second bounding surface of said first notch in each of said pair of clamps resting against said bottom surface of said extension plank, said second notch associated with each of said pair of clamps having a primary bounding surface and a secondary bounding surface, said primary bounding surface of said second notch associated with each of said pair of clamps angling inwardly between said top surface of a respective clamp and said secondary bounding surface, said secondary bounding surface of said second notch associated with each of said pair of clamps extending between said primary bounding surface and said first lateral side of a respective clamp having said secondary bounding surface of said second notch lying on a plane being oriented parallel to said bottom side of said respective clamp, said primary bounding surface of said second notch in each of said pair of clamps conforming to a respective one of said lateral bounding surfaces of a respective one of said pair of channels in said bottom surface of said extension plank, said secondary bounding surface of said second notch in each of said pair of clamps resting against said bottom surface of said extension plank, each of said pair of clamps having a screw well extending from said back side toward said front side, each of said pair of clamps being oriented such that said front side of each of said pair of end clamps is directed toward each other;
a pair of end caps, each of said pair of end caps being removably attached to opposing ends of said extension plank with respect to each other, each of said pair of end caps having a planar end and a rounded end, said planar end of each of said pair of end caps abutting a respective one of said first end and said second end of said extension plank, each of said pair of end caps having a screw hole extending between said rounded end and said planar end, said screw hole in each of said pair of end caps being aligned with a respective one of said pair of channels in said extension plank;
a pair of screws, each of said pair of screws extending through said screw hole in a respective one of said pair of end caps and a respective one of said pair of channels in said extension plank, each of said pair of screws extending into said screw well in a respective one of said pair of clamps, an outer surface of each of said pair of screws threadably engaging a bounding surface of said respective screw well, each of said pair of clamps traveling toward each other when said pair of screws is rotated in a first direction thereby enabling said pair of clamps to be compressed against said deck of said scooter, each of said pair of clamps travelling away from each other when said pair of screws is rotated in a second direction thereby enabling said pair of clamps to be displaced from said deck of said scooter for removing said extension plank from said deck; and
a pair of rollers, each of said pair of rollers being rotatably disposed on said extension plank wherein each of said pair of rollers is configured to roll along the support surface when said extension plank is attached to said deck of said scooter, each of said pair of rollers being spaced apart from each other on said extension plank thereby enabling each of said pair of rollers to be spaced laterally away from opposing sides of said deck with respect to each other thereby inhibiting said scooter from tipping laterally wherein each of said pair of rollers is configured to inhibit the user from tipping over when the user is riding said scooter, each of said pair of rollers being positioned on said bottom side of a respective one of said pair of clamps, each of said pair of rollers being positioned adjacent to said back side of said respective clamp, each of said pair of rollers being rotatable on said respective clamp about an axis extending between said top side and said bottom side of said respective clamp thereby enabling said pair of rollers to travel with said scooter when said scooter is steered to the left or to the right wherein said pair of rollers is configured to inhibit the user from tipping over when the user turns said scooter.

11. The device according to claim 10, wherein:
said extension plank has a pair of prominences each extending downwardly from said bottom surface of said extension plank;
each of said pair of prominences being spaced from a respective one of said first end and said second end of said extension plank and extends toward a center of said extension plank; and
each of said pair of prominences has a pair of lateral surfaces which each angles inwardly between a bottom surface of a respective prominence and said bottom surface of said extension plank such that each of said pair of prominences has a trapezoidal shape.

12. The device according to claim 11, wherein:
each of said pair of clamps has a slot extending between said front side and said back side of said clamps;
said slot in each of said pair of clamps has a pair of lateral bounding surfaces which each angle outwardly between said top side of a respective clamp and said bottom side of said respective clamp such that said slot in each of said pair of clamps has a trapezoidal shape; and
said slot in each of said pair of clamps insertably receives a respective one of said pair of prominences on said bottom surface of said extension plank having each of said pair of lateral bounding surfaces of said slot in a respective clamp conforming to a respective one of said pair of lateral surfaces of said respective prominence.

13. The device according to claim 12, wherein:
each of said pair of clamps has a pair of screw holes each extending between said front side and said back side of a respective clamp;
each of said pair of screw holes in said respective clamp is positioned on opposite sides of said slot in said respective clamp;
each of said pair of screws extends through a respective one of said pair of screw holes in each of said pair of clamps;
each of said pair of screws threadably engages a bounding surface of said respective screw hole in each of said pair of clamps;
each of said pair of clamps travels toward each other on said respective prominence when said pair of screws is rotated in said first direction for compressing said pair of clamps against said deck of said scooter; and
each of said pair of clamps travels away from each other on said respective prominence when said pair of screws is rotated in said second direction for displacing said pair of clamps from said deck of said scooter.

14. The device according to claim 11, wherein:
each of said pair of roller is rotatably attached to said bottom surface of said extension plank; and
each of said pair of rollers is positioned between a respective one of said pair of prominences and a respective one of said first end and said second end of said extension plank.
